(19) United States
(12) Patent Application Publication
(10) Pub. No.: US 2011/0231770 A1
(43) Pub. Date: Sep. 22, 2011

(54) SYSTEMS AND METHODS FOR A TEMPORARY MECHANISM FOR SELECTIVE BLOCKING OF INTERNET CONTENT

(76) Inventor: Tom C. Tovar, San Francisco, CA (US)

(21) Appl. No.: 12/897,237

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 15/16; G06F 3/048

(52) U.S. Cl. 715/736

(57) ABSTRACT

Systems and methods for a temporary mechanism for selective blocking of Internet content are described. A distraction list may be received from an Internet service via a user interface between an end user and the Internet service, wherein the distraction list includes one or more blocked Internet content identifiers associated with blocked Internet content. A focus-time interval defined by a starting time and a length of duration or an ending time is also received. If Internet content designated to be blocked is requested by the end user during the focus-time interval, the end user may be redirected to a block page. Monitoring may automatically cease after the focus-time interval, without requiring the end user to manually disable the selective blocking of Internet content.

### CROSS REFERENCES TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention relates generally to monitoring and regulating Internet use. The invention relates more particularly to systems and methods for providing a temporary mechanism for selective blocking of Internet content.

### SUMMARY OF THE INVENTION

In accordance to some embodiments of the present technology, an exemplary method for selective blocking of Internet content includes several steps. A distraction list may be received from an Internet service via a user interface between an end user and the Internet service, wherein the distraction list includes one or more blocked Internet content identifiers associated with blocked Internet content. A focus-time interval and a starting time are also received. Further, the exemplary method may include monitoring Internet content requested by the end user to determine if the blocked Internet content is requested after the starting time and during the focus-time interval. The monitoring may be performed by the Internet service. In some embodiments, the Internet service may be coupled to an Internet service provider. When the blocked Internet content is requested after the starting time and during the focus-time interval, the end user is redirected to a block page, which may thereby reduce online distractions for the duration of the focus-time interval. The monitoring automatically ceases after the focus-time interval, without requiring the end user to manually disable the selective blocking of Internet content.

An exemplary system for a temporary mechanism for selective blocking of Internet content may include the Internet service and a user interface between an initiating end user and the Internet service that receives a distraction list comprising one or more blocked Internet content identifiers associated with blocked Internet content, a focus-time interval, and a starting time. The user interface may operate between an end user and an Internet service provider. The system may be set up to utilize a DNS (Domain Name System) server or a cloud based networking system.

The exemplary system for a temporary mechanism for selective blocking of Internet content may also include a processor for executing the instructions stored in memory to monitor Internet content requested by the end user to determine if the blocked Internet content is requested after the starting time and during the focus-time interval. Furthermore, the processor may execute instructions stored in memory to redirect the end user to a block page when the blocked Internet content is requested after the starting time and during the focus-time interval, wherein the monitoring automatically ceases after the focus-time interval.

### BRIEF DESCRIPTION OF THE DRAWINGS

FIG. 1 is a flow chart of an exemplary method for a temporary mechanism for selective blocking of Internet content in accordance with various embodiments of the present invention.

FIG. 2 is a block diagram of an exemplary environment for a temporary mechanism for selective blocking of Internet content in accordance with various embodiments of the present invention.

FIG. 3 is an exemplary screenshot regarding an application for selective blocking of Internet content in accordance with various embodiments of the present invention.

FIG. 4 is an exemplary screenshot showing a user interface associated with an application for selective blocking of Internet content in accordance with various embodiments of the present invention.

FIG. 5 is an exemplary screenshot showing a user interface associated with an application for selective blocking of Internet content in accordance with various embodiments of the present invention.

FIG. 6 is a block diagram of a DNS server arrangement in accordance with various embodiments of the present invention.

FIG. 7 is a block diagram of an exemplary system for providing a temporary mechanism for selective blocking of Internet content in accordance with various embodiments of the present invention.

FIG. 8 is a block diagram of an exemplary system for a temporary mechanism for selective blocking of Internet content in accordance with various embodiments of the present invention.

### DETAILED DESCRIPTION

Generally speaking, an administrator may create and enforce mediation polices for one or more end users that utilize computing devices coupled to an Internet service delivered to a location such as a home, residence or place of business or campus. The term “administrator” may include not only individuals, such as parents, but also any individual creating a mediation policies regarding the Internet service delivered to end users. It will be understood that an administrator may also be an end user, although end users who are not also administrators may not create or apply policies.

It will be further understood that because of the diversity of computing devices that may connect to the Internet service, the policy may be applied to the Internet service rather than requiring the policy to affect each computing device individually, such as a mediation application resident on each computing device. In various exemplary embodiments a policy may also reside as a stand alone application on one or more of the computing devices.

Exemplary user devices for use with the disclosed systems may have a user interface. In various embodiments, such as those deployed on personal mobile devices, the user interface may be, or may execute, an application, such as a mobile application (hereinafter referred to as an “app”). An app may be downloaded and installed on a user's mobile device. Users may define a mediation policy via a user device, such as through the user interface. Some embodiments of the present invention do not require software to be downloaded or installed locally to the user device and, correspondently, do not require the user to execute a de-install application to cease use of the system.

Various embodiments of the present invention provide systems and methods for a temporary mechanism for selective blocking of Internet content on a user account and/or from designated Internet access devices. An initiating user may wish to restrict his or her access to Internet content so that the initiating user may focus on using specific applications or Internet content, relating to the initiating user's work or school projects, for example. An exemplary system for a temporary mechanism for selective blocking of Internet content may include the Internet service and a user interface between any initiating end user and the Internet service that receives a distraction list comprising one or more blocked Internet content identifiers associated with blocked Internet content, a focus-time interval and a starting time. The user interface may operate between an end user and an Internet service provider. The exemplary system for a temporary mechanism for selective blocking of Internet content may also include a processor for executing the instructions stored in memory to monitor Internet content requested by the end user to determine if the blocked Internet content is requested after the starting time and during the focus-time interval. Furthermore, the processor may execute instructions stored in memory to redirect the end user to a block page when the blocked Internet content is requested after the starting time and during the focus-time interval, wherein the monitoring automatically ceases after the focus-time interval.

The user interface may be requested though a gateway available to the end user. Gateways include but are not limited to desktops, PCs, laptops, notebooks, game consoles (e.g., an X-box), music players, tablets, IPods, Smartphones, automobile computer systems, and Internet enabled TVs. A Smartphone may be generally defined as a phone with computing capability. A Smartphone may provide Internet access to an end user.

It will be noted that as used herein the term “Internet content” encompasses any website, web service or other content or service presented to a user on the Internet or through a user device. The term “web content” is used herein to refer to any Internet content generated or requested by or through a web browser. For purposes of this disclosure, the definition of “Internet service provider” will include any service or technology that provides a connection to the Internet. Examples of such technologies include, but are not limited to, traditional Internet service providers (ISPs), telecommunications companies, cable operators, mobile operators, network operators and any other provider of wired or wireless access to Internet services.

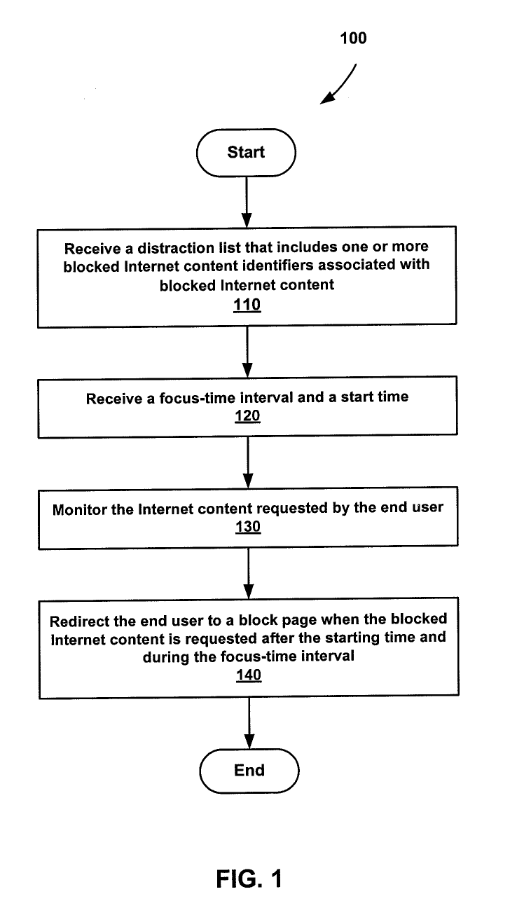

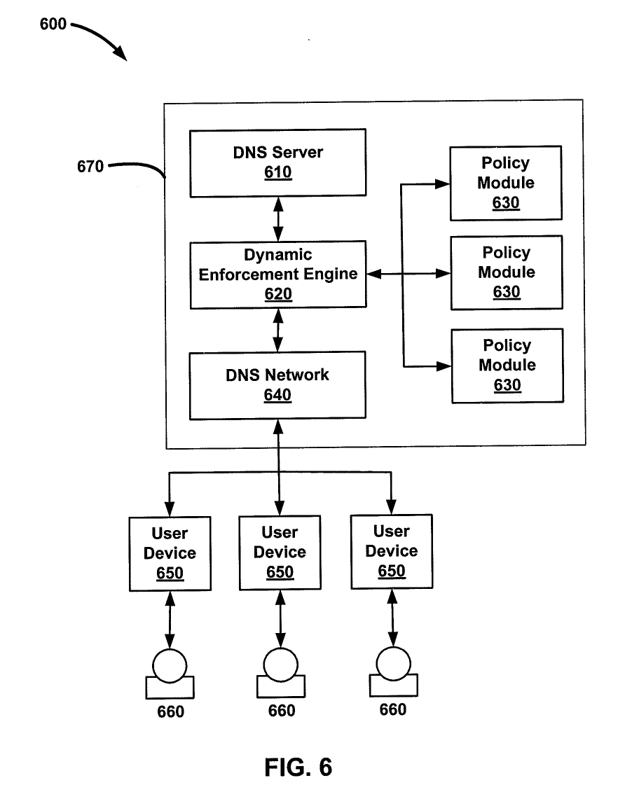

FIG. 1 is a flowchart of an exemplary method 100 for a temporary mechanism for selective blocking of Internet content. At step 110 of the method 100, a distraction list is received from an Internet service via a user interface between an initiating end user and the Internet service, wherein the distraction list includes one or more blocked Internet content identifiers associated with blocked Internet content. The user interface may be accessible by one or more user devices operated by the initiating end user. A DNS server may be coupled to the Internet service in various exemplary embodiments. The user interface may operate between any end user and the Internet service. User devices (such as user devices 650 of FIG. 6) may comprise various computing devices. If remote control of the method is desired, a portable computing device such as a Smartphone may be utilized as the control device to enable, disable or configure the Internet service. In this scenario, operating applications may reside on the user device 650.

The distraction list may include a list of one or more blocked Internet content identifiers, and may be provided by various sources, such as the Internet service and/or the user devices (e.g., input by the initiating end user, or retrieved from a stored file on the user device), either alone or in any combination thereof. A blocked Internet content identifier is associated with blocked Internet content, and may identify the blocked Internet content. The blocked Internet content identifier may include a web site address, uniform resource locator or identifier, and/or a title or name of the blocked Internet content. The one or more blocked Internet content identifiers may be associated with specific web content, such as a website, or be associated with at least one predetermined category of Internet content selected by the initiating end user. Each predetermined category may be associated with a content theme, which may describe subject matter that the Internet content listed under the predetermined category shares in common. The at least one predetermined category may include an entertainment content theme, a public email content theme, a social networking content theme, a shopping content theme, a sports content theme, a news content theme, and a gaming content theme in various embodiments. The user interface may also allow an initiating end user to select which Internet content is to be blocked, as described in further detail below.

The predetermined category of Internet content may include a pre-populated list of Internet content identifiers associated with Internet content having the content theme associated with the predetermined category. In such embodiments, the method 100 may also include the optional step of pre-populating the distraction list with Internet content identifiers that are associated with the predetermined category. In an exemplary embodiment, the list. The list of Internet content identifiers requested by the end user may be compared against the distraction list. The comparison may be performed by the DNS server via a query to the Internet service.

When blocked Internet content is requested during the focus-time interval and after the starting time, at step 140, the end user is redirected to a block page, thereby denying access to the blocked Internet content. In some embodiments, the block page is transmitted to display on a user device of the first distraction list may be displayed on a user interface that is provided to the first end user.

At step 120 of the method 100, a focus-time interval and a starting time are received via the user interface. The focus-time interval may be the time for which access to the blocked Internet content may be denied to the end user, and the starting time may be a time provided by the end user for the focus-time interval to commence. The starting time may also be provided by receiving a start input from the user indicating that the focus-time interval should commence. The start input may be provided by the user by selecting or otherwise actuating a command on the user interface, such as a button or command from a menu. Both the focus-time interval and the starting time may be received from various sources, such as the Internet service, and/or the user device, either alone or in any combination thereof.

At step 130, Internet content requested by the end user during the focus-time interval and after the starting time is monitored to determine if blocked Internet content is requested. The monitoring in step 130 may be performed by the Internet service which may, in turn, utilize a DNS server (such as the DNS server 610 of FIG. 6). Determining whether the blocked Internet content is being requested or used may be performed by receiving from the Internet service or the DNS server a list of Internet content identifiers that have been designated on the distraction end user via a user interface. The block page may take any suitable visual form, such as a web page or a pop-up window, for example. In various embodiments of the present technology, the block page may include a written explanation explaining why access to the blocked Internet content has been denied. The block page may also include instructions that explain how the end user may disable the block page and access the blocked Internet content. It may be appreciated that any engine, module, server, database, or any combination thereof may help to generate the block page. The monitoring automatically ceases after the focus-time interval, which may allow an end user additional flexibility compared to a mechanism that requires manual disabling of Internet content blocking functionality.

In an exemplary embodiment, the Internet content requested by the end user during the focus-time interval may be monitored to determine if the requested Internet content has the content theme of a predetermined category. The monitoring may be performed by searching the requested Internet content and/or metadata associated with the requested Internet content for predetermined keywords associated with the content theme. For example, monitoring for a predetermined category having a sports content theme may include searching the requested Internet content for predetermined keywords such as “basketball,” “baseball,” and “football.” In such embodiments, the end user may be redirected to the block page when Internet content having the content theme is requested during the focus-time interval.

In an exemplary embodiment, all Internet content that is requested after the starting time and during the focus-time interval may be blocked. Such an embodiment may be advantageous when an end user wishes to use the user device without accessing the internet, such as when the end user wishes to use productivity applications (e.g., word processing or spreadsheet applications).

Data characteristic of Internet use as evidenced by a history of requested content, etc., may be collected and used to generate or modify distraction lists by, for example, auto-populating distraction lists with Internet content identifiers determined to be associated with distracting Internet content.

It should be noted that an administrator may activate and deactivate any or all of the blocking function on demand. The administrator may also control each of the blocking schemes associated with multiple end users.

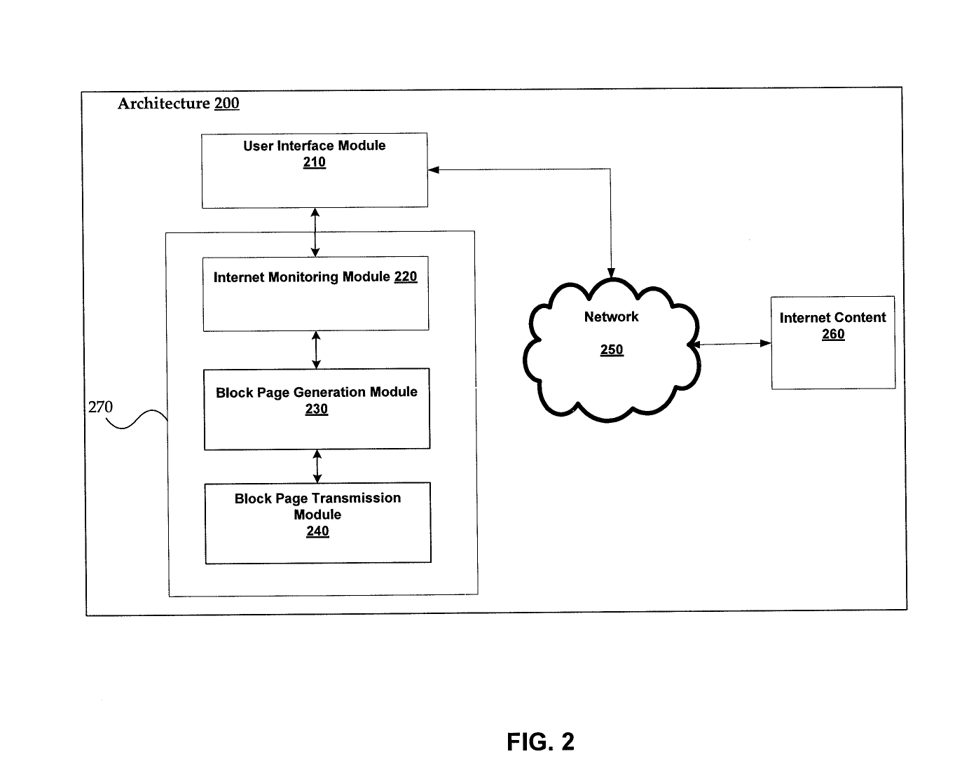

FIG. 2 illustrates an exemplary architecture 200 of an exemplary system for an application for selective blocking of Internet content. The architecture 200 includes a user interface module 210, an Internet monitoring module 220, a block page generation module 230, a block page transmission module 240, a network 250, and an Internet service 260. Alternative embodiments may comprise more, less, or functionally equivalent modules. Although various modules may be configured to perform some or all of the various steps described herein, fewer or more modules may be provided and still fall within the scope of various embodiments.

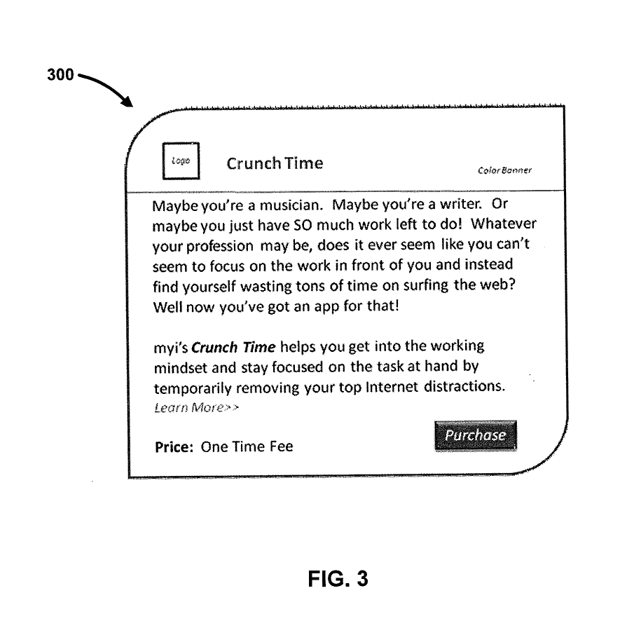

The user interface module 210 provides one or more user interfaces to the end user as a result of the application for selective blocking of Internet content. The user interface module 210 provides, for instance, a user interface between the end user and the Internet service, so that communications between the two are enabled. Exemplary user interfaces provided by the user interface module 210 are shown in FIGS. 3-5. The user interface module 210 may perform the steps of receiving a distraction list (such as in step 110 of the method 100 described earlier herein in relation to FIG. 1) and receiving a focus-time interval and a starting time (such as in step 120 of the method 100 described earlier herein in relation to FIG. 1).

The Internet monitoring module 220 may perform a step of monitoring Internet content requested by the end user during the focus-time interval to determine if blocked Internet content is requested (such as the step 130 of the method 100 described earlier herein in relation to FIG. 1). The block page generation module 230 may perform a step of generating a block page, and the block page transmission module 250 may perform a step of redirecting the end user to a block page when blocked Internet content is requested during the focus-time interval (such as the step 140 of the method 100 described earlier herein in relation to FIG. 1). Modules 220, 230, and 240 may be considered to constitute an Internet mediation system 270.

The architecture 200 includes a network 250 which may comprise a DNS server. The network 250 may also include any type and number of databases, servers, end users, computing devices, and policy engines. The one or more Internet content being monitored is shown as Internet content 260. It will be appreciated by one skilled in the art that the system in FIG. 2 may be merged with or used in conjunction with any of the other exemplary systems described herein, including but not limited to the systems shown in FIGS. 6-8.

FIG. 3 is an exemplary screenshot of a user interface 300 that may be presented to an end user. The exemplary screenshot 300 provides a written summary of an application for selective blocking of Internet content. Such an application may implement one or more methods described herein. The end user may click or otherwise actuate a “Learn More” link which will provide more information about the application for selective blocking of Internet content beyond the initial summary provided to the end user. The end user may purchase access to the application for selective blocking of Internet content by clicking or otherwise actuating the “Purchase” button. Following the purchase of the notification policy application, the end user may be provided an opportunity to download the application for selective blocking of Internet content onto their user device.

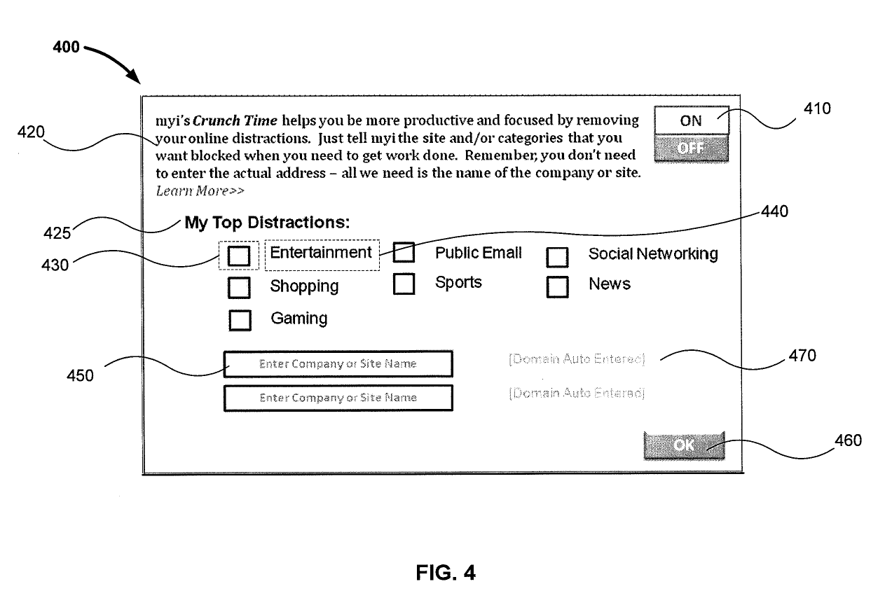

FIG. 4 is an exemplary screenshot of a user interface 400 for a temporary mechanism for selective blocking of Internet content. The user interface 400 may be displayed to an end user as part of an application for selective blocking of Internet content. The user interface 400 may include a configuration drawer. According to various embodiments, an end user may utilize the user interface 400 to set configurations of the application for selective blocking of Internet content. The user interface 400 may be used to receive at least one additional Internet content identifier and add the at least one additional Internet content identifier to the distraction list to form a modified distraction list. An optional summary 420 of the application for selective blocking of Internet content may be provided in the exemplary user interface 400. As shown in FIG. 4, the user interface 400 may include On/Off button set 410, one or more user entry fields 450, one or more domain fields 470, one or more predetermined categories 425, and an OK button 460.

The one or more user entry fields 450 are fields by which an end user may enter information regarding the at least one additional Internet content identifier. The user may enter a company name associated with an additional Internet content identifier, a site name associated with an additional Internet content identifier, a category name associated with an additional Internet content identifier, or any combination thereof. Categorized Internet content may be preloaded or otherwise stored as part of the application for selective blocking of Internet content.

After receiving a user entry (e.g., in the one or more user entry fields 450), a potential Internet content address corresponding to the user entry may be determined, and a domain field 470 may be auto-populated with the potential Internet content address. The potential Internet content address may be the actual URL address of the Internet content that the end user wants to add to the blocked list or a URL of an Internet content associated with an Internet content category provided by the end user in the user entry field 450.

If the potential Internet content address does not match what the end user wishes to add to the blocked list, the user may be presented with alternative Internet content addresses. At least one alternative Internet content address may be determined (e.g., by the Internet service) based upon the user entry in the user entry field 450. When a domain selection input is received, where the domain selection input may be selection or actualization of a button, for example, a selectable list may be provided that includes at least one alternative Internet content address. The selectable list may be a drop-down menu, for example, located in the domain field 470. The end user may select Internet content from the drop-down menu, and a URL to the selected Internet content from the drop-down menu may appear in the domain field 470.

Another way to provide additional Internet content identifiers to the distraction list may be provided using the one or more predetermined categories 425. Each predetermined category 425 may be associated with a selectable category button 430 and a category title 440. The category title 440 may include the content theme associated with the predetermined category. By selecting or otherwise actuating the category button 430, the end user may add all pre-stored Internet content identifiers associated with the predetermined category to the blocked list. Allowing end users to provide additional Internet content identifiers to the blocked list using the predetermined categories 425 may be advantageous because time may be saved compared to embodiments where the end user must enter additional Internet content identifiers individually using the user entry field 450 and the domain field 470.

End users may repeat the process of populating the domain fields 470 with additional Internet content identifiers until all of their selections have been furnished to the user entry fields 450. The at least one additional Internet content identifier may then be added to the distraction list to form a modified distraction list when a completion input is received. The completion input indicates that the user wishes to add the at least one additional Internet content identifier to the distraction list. When the completion input is received, the modifications to the distraction list may be saved for future use by clicking on or otherwise actuating the OK button 460, for example. Once the OK button 460 has been selected, the configuration drawer of the user interface 400 appears to close.

To activate the functionality of the application for selective blocking of Internet content, an end user may select, click or otherwise actuate the On button of the On/Off button set 410. If an initiating end user inputs their distraction list settings but does not enable the notification policy application by selecting the On button, then an overlay may appear to the end user asking if the end user would like to enable the service prior to closing the configuration drawer. In some embodiments, the default setting for the application for selective blocking of Internet content is “On.” If the end user wishes to disable the functionality of the application, the end user may select the Off button of the On/Off button set 410.

The systems and methods described above may typically be resident in an Internet service, a DNS server, or a DNS network. The systems and methods described may also be implemented in plug-in utilities, gateway devices, cable modems, proxy servers, set top boxes, and network interface devices.

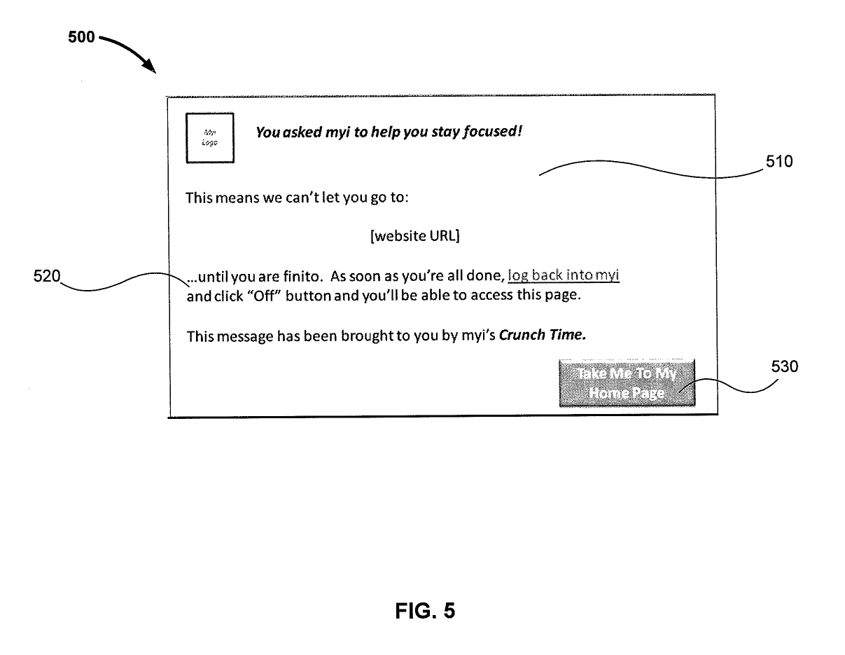

FIG. 5 is an exemplary screenshot of a user interface 500 for a temporary mechanism for selective blocking of Internet content. The user interface 500 may be displayed to an end user as part of an application for selective blocking of Internet content, and may be presented as a block page in an exemplary embodiment. The block page 500 may include a written blocking explanation 510 explaining why access to the blocked Internet content has been denied. The block page 500 may also include unblocking instructions 520 explaining how to access the blocked Internet content. As shown in FIG. 5, the user interface 500 may include a home page button 530, which may be used to return the end user to a home page. As an optional feature, the end user may also be provided with the ability to provide a disable block request in various embodiments. The disable block request may have the effect of truncating the focus-time interval so that the end user may access the blocked Internet content without being redirected to the block page 500. The Internet service may transmit a secondary check message, wherein the secondary check message provides a disable confirmation option to the end user. The secondary check message may be presented in a pop-up window, or as a web page, for example, and may provide the disable confirmation option to the end user as a selectable button. The focus-time interval may be terminated when a disable confirmation input is received. The disable confirmation input may be provided by selecting or otherwise actuating the disable confirmation option.

FIG. 6 illustrates an exemplary Internet service system 600, with a DNS network, that may be utilized to support the above described systems and methods. A DNS server 610 operates in conjunction with a dynamic enforcement engine 620. The dynamic enforcement engine 620 may operate in conjunction with one or more policy modules 630 to establish any applicable polices at the DNS level. The content rules are applied to received user queries, and determine the content that is delivered by the DNS network 640 through various user devices 650 to the end users 660.

The dynamic enforcement engine 620 may generate its policy engine on instructions received from one or more policy modules 630. Each policy module 630 may be constructed to provide various types and levels of services to the DNS network 640. In various embodiments, a policy module 630 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more user devices 650.

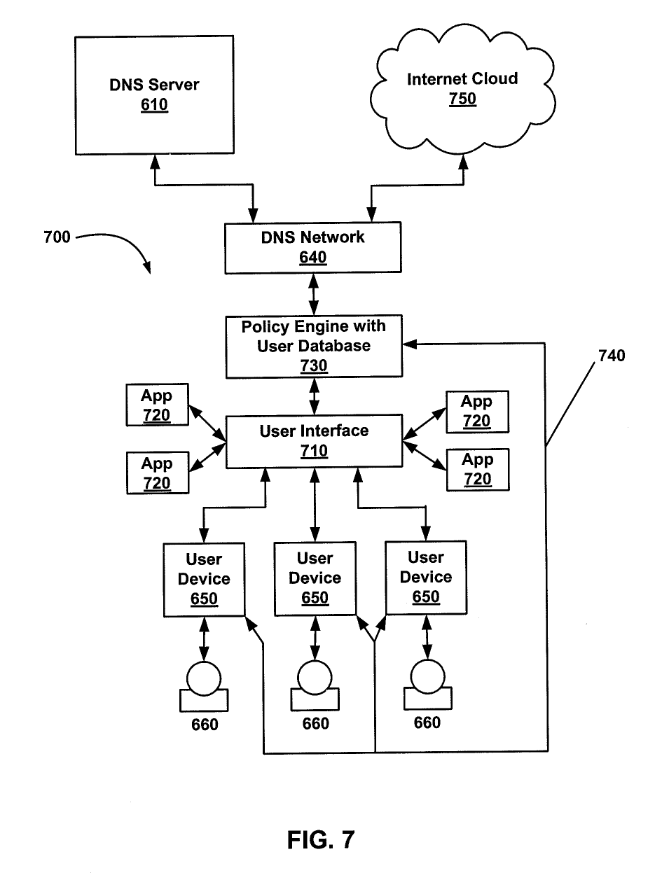

FIG. 7 shows a schematic layout of an exemplary system 700 for implementing direct and variable end user control. FIG. 7 illustrates that the system 700 may operate installed on a DNS server 610, or with a cloud 750 based installation.

The system 700 utilizes a user interface 710. The user interface 710 may be implemented in many embodiments. One specific implementation of the user interface 710 is as a web page.

The user interface 710 may be requested by one or more user devices 650 operated by the users 660. The user interface 710 may be requested though a gateway user device 650 available to the users 660. Suitable user devices 650 include but are not limited to desktops, PCs, laptops, notebooks, gaming devices, IPods, IPhones, automobile computer systems, and Internet enabled TVs. The system 700 may also be requested and controlled through remote control user devices 650, such as a Smartphone. A Smartphone may be defined as a phone with computing capability. A Smartphone may provide the user 660 with Internet access.

The user interface 710 provides a mechanism for one or more authorized users 660 to establish content policy for the Internet service. The user interface 710 operates between the user devices 650 present in the system 700 and the DNS network 640. Instructions resident on the user interface 710 therefore operate on the Internet service, by controlling at least a portion of DNS resolutions via a dynamic policy engine 730, before the service reaches the displays of the user devices 650.

The user interface 710 provides the users 660 with access to one or more policy applications 720. The user interface 710 may provide access to a selection list to at least one authorized user 660. The authorized user 660 uses the selection list or some other menu mechanism to select those policy applications 720 that the user 660 chooses to apply to the system 700. The authorized user 660 may select any number of the available policy applications for use on the system 700 at any given time. In implementations utilizing Smartphones as the user device 650, the policy applications 720 are downloaded to the device 650. The device 650 then serves as the user interface 710 to communicate directly with the dynamic policy engine 730.

The policy applications 720 may prohibit access to specific sites. The policy applications 720 may also limit the time of day when users or selected users 660 may access certain sites. The policy applications 720 may also manage and analyze duration of access to various sites. It is important to note that the policy applications 720 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 720 may provide notifications or alerts to one or more users 660 when sites are requested. The policy applications 720 may also provide notification of frequency and duration of access of designated sites. The policy applications 720 may also be used to observe, substitute, enable, redirect users, to reward behavior desired from the users by a system administrator, etc. The policy applications 720 may redirect users from a non-favored site to another site. The policy applications 720 may also collect and transmit data characteristic of Internet use. The data characteristic of Internet use may be used to generate or modify distraction lists by, for example, auto-populating distraction lists with Internet content identifiers determined to be associated with distracting Internet content.

Access policies supplied by the policy applications 720 may apply to all users 660 of the system 700, or the access policies may be specific to individual users or groups of users 660. The policy applications 720 may be discrete, single purpose applications.

The policy applications 720 provide the users 650 with a mechanism to take various actions relative to their Internet service feed. The policy applications 720 also allow the users 650 to establish a dynamic policy engine 730 that includes a user database. The policy engine 730 is used to enforce rules associated with each policy application associated with individual end users, not simply block various inappropriate sites from the Internet feed. Rather, the dynamic policy engine 730, controlled by the user interface 710 through user device(s) 650, is used to manage all aspects of the Internet experience for the users 660. In sum, the policy applications 720 may be used to configure the dynamic policy engine 730 to provide the users 660 with a mechanism to personalize the Internet experience. The policy applications 720 may be configured in combinations, and may each be separately configured.

The database in the policy engine 730 may be used to record and to notify users 660 of various data relative to Internet access. The data collected from and provided to the users 660 may include records of access of specific sites, time spent on specific sites, time of day of access, data specific to individual users, etc.

It should also be noted that following an initial setup through the user interface 710 of the policy engine 730, a direct access 740 enforcement loop may be established between the policy engine 730 and the user devices 650. Subsequent accessing of the DNS network 640 utilizing the direct access 740 decreases response time in the system 700, thereby further enhancing the Internet experience of the users 660. Configurations of policy applications 720 that are selected by one or more users 660 designated as system administrators may remain in the user database of the policy engine 730 until such time as it may be modified by the system administrators. The system administrators may define multiple policy configurations, with a combination of policy applications 720, applicable to one or more end users 660 of the system 700. Each policy application 720 may be separately configurable as well. Policy configurations may vary based upon designated times, conditional triggers, or specific requests from the users 660 with administrative authority.

As indicated above, two discrete data flow paths may be established for the system 700. A first data path establishes a set of enforcement policies for the system 700. The first data path flows from at least one user device 650 through the user interface 710, to the policy enforcement engine 730. A second data path 740 may be utilized following the establishment of a set of policies for the system 700. The second data path 740 flows directly between the user device(s) 650 and the policy engine 730. Multiple sets of enforcement policies may be established and saved within the system 700 and implemented selectively by the users 660.

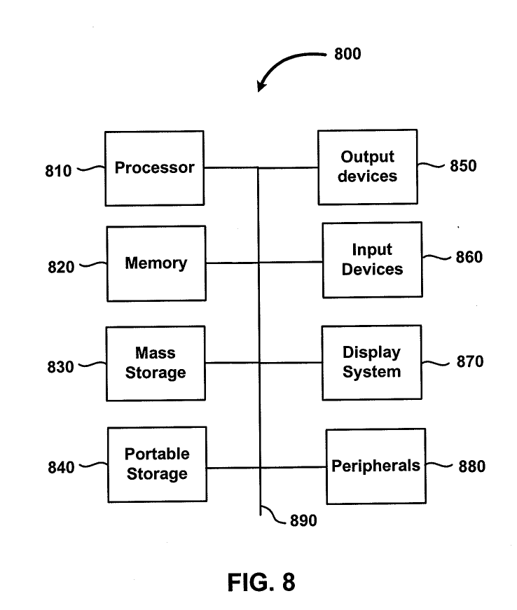

FIG. 8 illustrates an exemplary computing system 800 that may be used to implement an embodiment of the present invention. System 800 of FIG. 8 may be implemented in the context of user devices 650, DNS server 610, Internet cloud 750 and the like. The computing system 800 of FIG. 8 includes one or more processors 810 and memory 820. Main memory 820 stores, in part, instructions and data for execution by processor 810. Main memory 820 can store the executable code when the system 800 is in operation. The system 800 of FIG. 8 may further include a mass storage device 830, portable storage medium drive(s) 840, output devices 850, user input devices 860, a graphics display 840, and other peripheral devices 880.

The components shown in FIG. 8 are depicted as being connected via a single bus 890. The components may be connected through one or more data transport means. Processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by an user device including but not limited to one or more of web sites, domains, web pages, web addresses, hyperlinks, URLs, any text, pictures, and/or media (such as video, audio, and any combination of audio and video) provided or displayed on a web page, and any combination thereof. Mediating the Internet service may include any of blocking, constraining, enabling, redirecting, promoting, demoting, substituting, obscuring, limiting, interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for blocking Internet content, the method comprising:
receiving a distraction list from an Internet service via a user interface between an initiating end user and the Internet service, wherein the distraction list comprises one or more blocked Internet content identifiers associated with blocked Internet content, a focus-time interval and a starting time;
monitoring Internet content requested by the end user to determine if the blocked Internet content is requested after the starting time and during the focus-time interval; and
redirecting the end user to a block page when the blocked Internet content is requested after the starting time and during the focus-time interval, wherein the monitoring automatically ceases after the focus-time interval.

2. The method of claim 1, wherein one or more blocked Internet content identifiers comprise at least one category of Internet content, each category comprising a content theme.

3. The method of claim 2, wherein the method further comprises:
monitoring Internet content requested by the end user after the starting time and during the focus-time interval to determine if Internet content having the content theme is requested; and
redirecting the end user to the block page when Internet content having the content theme is requested after the starting time and during the focus-time interval.

4. The method of claim 2, wherein the category of Internet content comprises a pre-populated list of Internet content identifiers associated with Internet content associated with the category.

5. The method of claim 2, wherein the at least one category is predetermined and comprises at least one of an entertainment content theme, a public email content theme, a social networking content theme, a shopping content theme, a sports content theme, a news content theme, and a gaming content theme.

6. The method of claim 1, further comprising receiving at least one additional Internet content identifier and adding the at least one additional Internet content identifier to the distraction list to form a modified distraction list.

7. The method of claim 6, wherein the receiving the at least one additional Internet content identifier comprises:
receiving a user entry;
determining an Internet content corresponding to the user entry; and
auto-populating a distraction list with the Internet content.

8. The method of claim 6, wherein the distraction list is auto-populated based on end user behavior not associated with receiving a user entry.

9. The method of claim 6, wherein the receiving the at least one additional Internet content identifier further comprises:
determining at least one alternative Internet content address based upon the user entry;
receiving content selection input; and
providing a selectable list comprising the at least one alternative Internet content address.

10. The method of claim 6, wherein the at least one additional Internet content identifier is added to the distraction list to form a modified distraction list when a completion input is received, wherein the completion input indicates that the user wishes to add the at least one additional Internet content identifier to the distraction list.

11. The method of claim 1, further comprising blocking all Internet content that is requested after the starting time and during the focus-time interval.

12. The method of claim 1, wherein the method further comprises:
receiving a disable block request during the focus-time interval;
transmitting a secondary check message, wherein the secondary check message provides a disable confirmation option to the end user; and
terminating the focus-time interval when a disable confirmation input is received.

13. The method of claim 1, wherein the block page comprises a written blocking explanation and unblocking instructions.

14. The method of claim 1, wherein the user activates and deactivates blocking on demand.

15. The method of claim 14, wherein the user defines predetermined time periods of activating and deactivating blocking.

16. The method of claim 1, wherein any end user can implement a personalized distraction list and activate blocking.

17. The method of claim 1, wherein different distraction policies are simultaneously applied to different end users.

18. The method of claim 1, wherein customized notifications are generated when designated Internet content identifiers are accessed.

19. The method of claim 1, wherein advisory policies are recommended to an administrator based on end user access request history.

20. The method of claim 1, wherein the Internet service monitors end user internet activity and generates suggested advisory policies specific to end users.

21. The method of claim 20, wherein an administrator is notified of additional Internet services or applications.

22. The method of claim 1, wherein at least one element of the Internet service resides on a user device.

23. The method of claim 1, wherein at least one of the Internet content identifiers resides on a DNS server.

24. The method of claim 1, wherein at least a portion of the Internet content identifiers are enforced by DNS server.

25. The method of claim 1, wherein a user can set specific Internet content identifiers for specific locations.

26. A system for blocking Internet content, the system comprising:
a user interface between an initiating end user and an Internet service that receives a distraction list, wherein the distraction list comprises one or more blocked Internet content identifiers associated with blocked Internet content and a focus-time interval defined by a starting time and a length of duration or an ending time; and
a processor for executing instructions stored in memory to:
monitor Internet content requested by the end user to determine if the end user requested blocked Internet content during the focus-time interval; and
redirect the end user to a block page when the blocked Internet content is requested during the focus-time interval, wherein the monitoring automatically ceases after the focus-time interval has elapsed.

27. The system of claim 26, wherein the one or more blocked Internet content identifiers comprise at least one predetermined category of Internet content, each predetermined category comprising a content theme.

28. The system of claim 27, wherein the processor is further configured to execute instructions stored in memory to:
monitor the Internet content requested by the end user after the starting time and during the focus-time interval to determine if Internet content having the content theme is requested; and
redirect the end user to the block page when Internet content having the content theme is requested after the starting time and during the focus-time interval.

29. The system of claim 27, wherein the predetermined category of Internet content comprises a pre-populated list of Internet content identifiers associated with Internet content having the content theme associated with the predetermined category.

30. The system of claim 27, wherein the at least one predetermined category comprises an entertainment content theme, a public email content theme, a social networking content theme, a shopping content theme, a sports content theme, a news content theme, and a gaming content theme.

31. The system of claim 26, wherein the processor is further configured to execute instructions stored in memory to receive at least one additional Internet content identifier and adding at least one additional Internet content identifier to the distraction list to form a modified distraction list.

32. The system of claim 31, wherein the instructions stored in memory to receive the at least one additional Internet content identifier comprise instructions stored in memory to:
receive a user entry;
determine a potential Internet content address corresponding to the user entry; and
auto-populate a domain field with the potential Internet content address.

33. The system of claim 31, wherein the instructions stored in memory to receive the at least one additional Internet content identifier further comprise instructions stored in memory to:
determine at least one alternative Internet content address based upon the user entry;
receive a domain selection input; and
provide a selectable list comprising the at least one alternative Internet content address.

34. The system of claim 31, wherein the at least one additional Internet content identifier is added to the distraction list to form a modified distraction list when a completion input is received, wherein the completion input indicates that the user wishes to add the at least one additional Internet content identifier to the distraction list.

35. The system of claim 26, wherein the processor is further configured to execute instructions stored in memory to block all Internet content that is requested during the focus-time interval.

36. The system of claim 26, wherein the processor is further configured to execute instructions stored in memory to:
receive a disable block request during the focus-time interval;
transmit a secondary check message, wherein the secondary check message provides a disable confirmation option to the end user; and
terminate the monitoring function when a disable confirmation input is received.

37. The system of claim 26, wherein the block page comprises a written explanation for blocked Internet content and instructions that indicate to the user how to disable blocking.

38. The system of claim 26, wherein an element of the Internet service reside on a user device.

39. A non-transitory computer-readable storage medium having embodied thereon a program, the program executable by a processor in a computing device to perform a method for providing reminders, the method comprising:
receiving a distraction list from an Internet service via a user interface between an initiating end user and the Internet service, wherein the distraction list comprises one or more blocked Internet content identifiers associated with blocked Internet content, a focus-time interval and a starting time;
monitoring Internet content requested by the end user to determine if the user requested blocked Internet content during the focus-time interval; and
redirecting the end user to a block page when the blocked Internet content is requested during the focus-time interval, wherein the monitoring automatically ceases after the focus-time interval.

40. A method for blocking Internet content, the method comprising:
receiving a distraction list via a user interface between an initiating end user and the Internet service, wherein the distraction list comprises one or more blocked Internet content identifiers associated with blocked Internet content, a focus-time interval, and a starting time;
monitoring in the DNS server Internet content requested by the end user to determine if the user requested blocked Internet content after the starting time and during the focus-time interval; and
redirecting at the DNS server the end user to a block page when the blocked Internet content is requested after the starting time and during the focus-time interval, wherein the monitoring in the DNS server automatically ceases after the focus-time interval.

41. The method of claim 40, wherein one or more blocked Internet content identifiers comprise at least one category of Internet content, each category comprising a content theme.

42. The method of claim 41, wherein the method further comprises:
monitoring Internet content requested by the end user in the DNS server after the starting time and during the focus-time interval to determine if Internet content having the content theme is requested; and
redirecting in the DNS server the end user to the block page when Internet content having the content theme is requested after the starting time and during the focus-time interval.

43. The method of claim 41, wherein the category of Internet content comprises a pre-populated list of Internet content identifiers associated with Internet content associated with the category.

44. The method of claim 41, wherein the at least one category is predetermined and comprises at least one of an entertainment content theme, a public email content theme, a social networking content theme, a shopping content theme, a sports content theme, a news content theme, and a gaming content theme.

45. The method of claim 40, further comprising receiving at least one additional Internet content identifier and adding the at least one additional Internet content identifier to the distraction list to form a modified distraction list in the DNS server.

46. The method of claim 45, wherein the receiving the at least one additional Internet content identifier comprises:
receiving a user entry;
determining an Internet content corresponding to the user entry; and
auto-populating a distraction list in the DNS server with the Internet content.

47. The method of claim 45, wherein the distraction list is auto-populated based on past activity of the end user, the activity being recorded by the DNS server.

48. The method of claim 45, wherein the receiving the at least one additional Internet content identifier further comprises:
determining at least one alternative Internet content address based upon the user entry;
receiving content selection input; and
providing a selectable list comprising the at least one alternative Internet content address.

49. The method of claim 45, wherein the at least one additional Internet content identifier is added to the distraction list in the DNS server to form a modified distraction list when a completion input is received, wherein the completion input indicates that the user wishes to add the at least one additional Internet content identifier to the distraction list in the DNS server.

50. The method of claim 40, further comprising redirection all request at the DNS server after the starting time and during the focus-time interval.

51. The method of claim 40, wherein the method further comprises:
receiving at the DNS server a disable block request during the focus-time interval;
transmitting a secondary check message, wherein the secondary check message provides a disable confirmation option to the end user; and
terminating the focus-time interval when a disable confirmation input is received.

52. The method of claim 40, wherein the block page comprises a written blocking explanation and unblocking instructions.

53. The method of claim 40, wherein the administrator activates and deactivates blocking on demand.

54. The method of claim 53, wherein the administrator defines predetermined time periods of activating and deactivating blocking.

55. The method of claim 40, wherein any end user can implement a personalized distraction list in the DNS server and activate blocking.

56. The method of claim 40, wherein different distraction policies are simultaneously applied to different end users in the DNS server.

57. The method of claim 40, wherein customized notifications are generated when designated Internet content is accessed.

58. The method of claim 40, wherein advisory policies are recommended to an administrator based on end user access request history recorded by the DNS server.

59. The method of claim 40, wherein the DNS server monitors end user internet activity and generates suggested advisory policies specific to end users.

60. The method of claim 59, wherein an administrator is notified of additional Internet services or applications.

61. The method of claim 40, wherein at least a part of the Internet service is resident on a user device.

62. A system for blocking Internet content, the system comprising:
a user interface between an initiating end user and an Internet service that receives a distraction list, wherein the distraction list comprises one or more blocked Internet content identifiers associated with blocked Internet content, a focus-time interval defined by a starting time and a length of duration or an ending time; and
a processor for executing instructions stored in memory to:
monitor in the DNS server Internet content requested by the end user to determine if the end user requested blocked Internet content during the focus-time interval; and
redirect the end user to a block page when the blocked Internet content is requested during the focus-time interval, wherein the monitoring automatically ceases after the focus-time interval has elapsed.

63. The system of claim 62, wherein the one or more blocked Internet content identifiers comprise at least one predetermined category of Internet content, each predetermined category comprising a content theme.

64. The system of claim 63, wherein the processor is further configured to execute instructions stored in memory to:
monitor in the DNS server the Internet content requested by the end user after the starting time and during the focus-time interval to determine if Internet content having the content theme is requested; and
redirect, in the DNS server, the end user to the block page when Internet content having the content theme is requested after the starting time and during the focus-time interval.

65. The system of claim 63, wherein the predetermined category of Internet content comprises a pre-populated list of Internet content identifiers associated with Internet content having the content theme associated with the predetermined category.

66. The system of claim 63, wherein the at least one predetermined category comprises an entertainment content theme, a public email content theme, a social networking content theme, a shopping content theme, a sports content theme, a news content theme, and a gaming content theme.

67. The system of claim 62, wherein the processor is further configured to execute instructions stored in memory to receive at least one additional Internet content identifier and adding at least one additional Internet content identifier to the distraction list to form a modified distraction list in the DNS server.

68. The system of claim 67, wherein the instructions stored in memory to receive the at least one additional Internet content identifier comprise instructions stored in memory to:
receive a user entry;
determine a potential Internet content address corresponding to the user entry; and
auto-populate a domain field in the DNS server with the potential Internet content address.

69. The system of claim 67, wherein the instructions stored in memory to receive the at least one additional Internet content identifier further comprise instructions stored in memory to:
determine at least one alternative Internet content address based upon the user entry;
receive a domain selection input; and
provide a selectable list comprising the at least one alternative Internet content address.

70. The system of claim 67, wherein the at least one additional Internet content identifier is added to the distraction list to form a modified distraction list when a completion input is received, wherein the completion input indicates that the user wishes to add the at least one additional Internet content identifier to the distraction list.

71. The system of claim 62, wherein the processor is further configured to execute instructions stored in memory to block all Internet content that is requested during the focus-time interval.

72. The system of claim 62, wherein the processor is further configured to execute instructions stored in memory to:
receive a disable block request during the focus-time interval;
transmit a secondary check message, wherein the secondary check message provides a disable confirmation option to the end user; and
terminate the monitoring function when a disable confirmation input is received.

73. The system of claim 62, wherein the block page comprises a written explanation for blocked Internet content and instructions that indicate to the user how to disable blocking.

74. The system of claim 62, wherein at least a part of the Internet service is resident on a user device.

75. The system of claim 62, wherein at least one element of the Internet service resides on a user device.

76. The system of claim 62, wherein a user can set specific Internet content identifiers for specific locations.
